(19) United States
(12) Patent Application Publication
(10) Pub. No.: US 2004/0215701 A1
(43) Pub. Date: Oct. 28, 2004

(54) Mobile contractor performance evaluation system and method

(76) Inventor: Sasha Vrajich, Plano, TX (US)

Correspondence Address: HUNTON & WILLIAMS LLP, 1601 BRYAN STREET, ENERGY PLAZA - 30TH FLOOR, DALLAS, TX, 75201, US

(21) Appl. No.: 10/746,441

(22) Filed: Dec. 23, 2003

Related U.S. Application Data
(60) Provisional application No. 60/436,413, filed on Dec. 23, 2002.

(51) Int. Cl. G06F 15/16

(52) U.S. Cl. 709/201

(57) ABSTRACT

A mobile performance evaluation system for inspecting a site is provided. The system includes a main system having a storage portion and a mobile unit operable to communication with the main system. The mobile unit includes a storage portion and an input portion. The system also includes an inspection survey database for information related to the inspection of the site. At least a portion of the inspection survey database resides on one of the storage portion of the main system and the storage portion of the mobile unit. The system further includes an inspection survey interface coupled to the inspection survey database and the input portion of the mobile unit to update the inspection survey database via the mobile unit. In one aspect, the mobile unit wirelessly communicates with the main system. A method of evaluating the performance of contractors is also provided.

### CROSS-REFERENCE TO RELATED APPLICATIONS

Pursuant to 35 U.S.C. § 119 (e), this application claims priority from, and hereby incorporates by reference for all purposes, U.S. Provisional Patent Application Serial No. 60/436,413, entitled Mobile Contractor Performance Evaluation System and Method, naming Sasha Vrajich as inventor, filed Dec. 23, 2002.

### TECHNICAL FIELD OF THE INVENTION

This invention relates in general to the field of evaluation systems and more particularly, but not by way of limitation, to a mobile contractor performance evaluation system and method.

### BACKGROUND OF THE INVENTION

Frequently it is necessary to inspect sites, such as where buildings or facilities are being constructed, to verify that the construction activities are conducted in accordance with agreed or required guidelines. When constructing facilities, for example, for electric utilities, it may be advantageous to monitor the progress of the construction to ensure that construction adheres to certain safety and regulatory guidelines.

Random or periodic inspections may focus on the quality of the construction and materials or compliance with safety requirements. Other types of inspections may verify the facilities' readiness to be utilized and begin transporting or distributing, for example, electricity.

In any event, an inspector physically observes the construction site noting general conditions and information based on the nature of the inspection. A survey form or inspection report is generally utilized by the inspector and includes itemized questions or criteria relevant to the type of inspection. The completed inspection report is typically reviewed for quality control and assurance purposes prior to, for example, initiation of electric service to the constructed facility.

In many instances, the construction site does not satisfy all the requirements during the initial inspection. For example, inspections may be terminated prematurely when the site is deficient in some respect and the builder or contractor is given an opportunity to remedy the deficiency. Also, although the inspector may consider a particular site inspection completed, the quality reviewer may identify an incomplete or inaccurate report, requiring the inspector to schedule a follow-up inspection.

In either case, the delay causes the contractor or builder delays that are time-consuming and costly. Also, such an inspection process is inefficient for the inspector and inspecting organization.

### SUMMARY OF THE INVENTION

From the foregoing it may be appreciated that a need exists for an improved system for performing and evaluating the performance of contractors and builders that overcomes these and other disadvantages. In accordance with the present invention, a mobile performance evaluation system and corresponding methods have been provided.

According to one aspect of the invention, a mobile performance evaluation system, hereafter referred to as system, for inspecting a site has been provided which includes a main system with a storage portion, a mobile unit, an inspection survey database, and an inspection survey interface. The mobile unit is operable to communicate with the main system, the mobile unit including a storage portion and an input portion. The inspection survey database includes information related to the inspection of the site; and, at least a portion of the inspection survey database resides on at least one of the storage portion of the main system and the storage portion of the mobile unit. The inspection survey interface is in communication with the inspection survey database and the input portion of the mobile unit to update the inspection survey database via the mobile unit.

In one configuration, at least a portion of the inspection survey database is stored on the storage portion of the main system and the storage portion of the mobile unit. In another configuration, the system includes a synchronization module to periodically synchronize the portion of the inspection survey database on the storage portion of the mobile unit with the portion of the inspection survey database stored on the storage portion of the main system.

In one configuration, the system includes an email and calendaring database. In yet another configuration, the mobile system wirelessly updates the inspection survey database

In another aspect of the invention, a method of surveying a construction site prior to initiating electric service to the construction site has been provided. The method comprises determining whether the electric construction site is an overhead or underground electric construction site; providing a mobile unit having a wireless communication portion and a storage portion; providing an electronic construction site survey on the mobile unit for inspecting overhead and underground construction sites, the electronic construction site survey including criteria for evaluating whether the construction site is prepared to receive electric service; inspecting the construction site; entering survey data into the electronic construction site survey on the mobile unit based on the inspection of the construction site; storing the survey data on the storage portion of the mobile unit; transmitting at least a portion of the survey data from the mobile unit to a main system; evaluating the survey data received by the main system to verify whether the construction site is prepared to receive electric service; transmitting the survey response data from the main system to the mobile unit; and evaluating the survey response data to determine whether the construction site satisfied the criteria for receiving electric service.

One advantage of the present invention is that the mobile unit is in communication, wirelessly in some configurations, with the main system, allowing for inspection without the need to return to a main office to key or re-enter the inspection survey information. This saves time, improves efficiency and eliminates data entry errors. Where the survey information is wirelessly transmitted to the main system from the mobile unit, a quality reviewer may review the inspection survey while the inspector remains at the inspection site, further improving efficiency.

Also, the inspector, such as via the mobile unit, may wirelessly receive the response from the quality reviewer, eliminating the need to return to the construction site when deficiencies in the inspection survey are identified by the quality reviewer. This is another advantage since one aspect of the present invention eliminates the need to reschedule inspection. Also, inspection surveys may be electronically stored on the mobile unit for return or follow-up inspections where the construction site is deficient in some respect.

In the wireless configurations, the inspection survey databases and other databases may be partially or completely resident on both the main system and mobile and the present invention may include a synchronization module to synchronize these databases wireless at any time. This is another advantage since updated survey and inspection information, email schedules and a plurality of other information may be communicated without the need for the inspector to return to the office. The quality reviewer, for example, may include comments in a comments field of the database to ask questions or request additional information of the inspector.

Another advantage is that the architecture utilized may allow the present invention to be implemented on any wireless frequency providing additional versatility.

Other technical advantages are readily apparent to one skilled in the art from the following figures and description.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is a diagrammatic illustration of one aspect of a mobile performance evaluation system constructed in accordance with the present invention utilizing a mobile unit in communication with a main system;

FIG. 2 is a diagrammatic illustration of another aspect of the present invention employing communication technologies for synchronizing information between the main system and the mobile unit;

FIG. 3 is a block diagram illustrating the association of an inspection survey database and an inspection survey interface according to one aspect of the present invention;

FIG. 4 is a view of one aspect of the inspection survey interface for receiving survey information into the mobile performance evaluation system of the present invention;

FIG. 5 is a view of another aspect of the inspection survey interface for receiving survey information into the mobile performance evaluation system of the present invention; and

FIG. 6 is flow-chart illustrating a method of inspecting sites according to one aspect of the present invention.

### DETAILED DESCRIPTION OF THE INVENTION

It should be understood at the outset that although an exemplary implementation of the present invention is illustrated below, the present invention may be implemented using any number of techniques, whether currently known or in existence. The present invention should in no way be limited to the exemplary implementations, drawings, and techniques illustrated below, including the exemplary design and implementation illustrated and described herein.

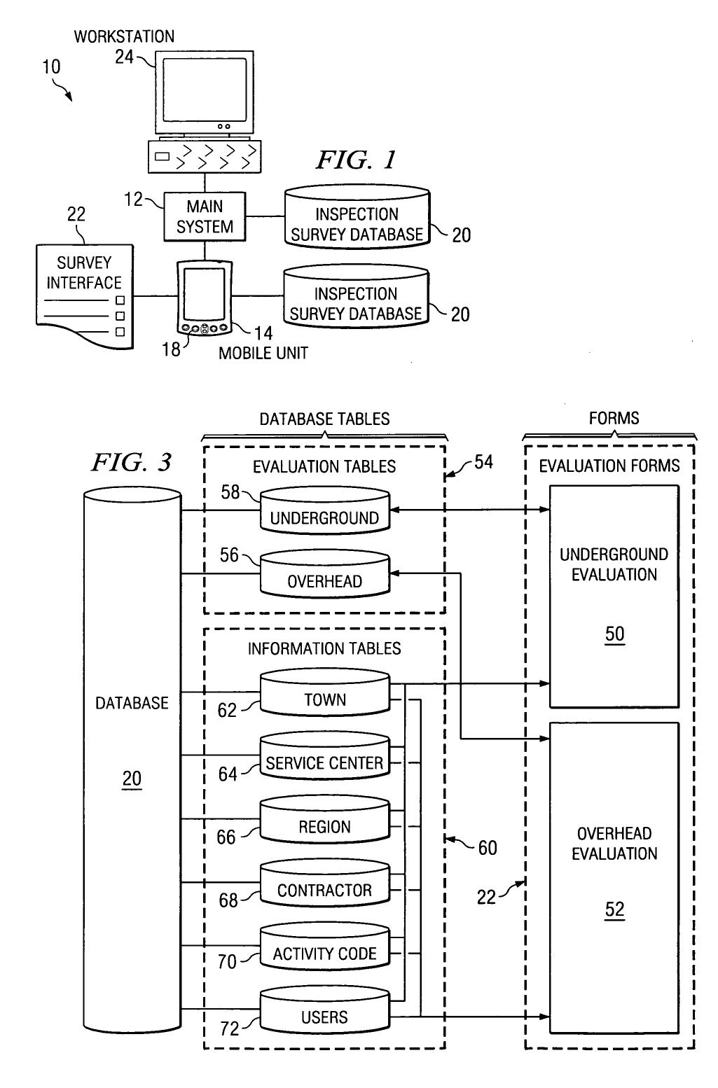

FIG. 1 is a diagrammatic illustration of the mobile performance evaluation system, hereinafter referred to as evaluation system 10, for inspecting sites, such as construction or building sites. According to one aspect of the present invention, the evaluation system 10 includes a main system 12 which is illustrated as a network server, according to the present aspect. In other aspects the main system 12 may be a single personal computer, work station, or other network device operable for communicating, storing and retrieving computer data. The main system 12 may include additional components and subsystems, some of which will be discussed in greater detail hereinafter. While such components will be discussed, it should be understood that other components can be utilized as will become apparent to one skilled in the art—such other components including those that are now known and those that are later developed.

The evaluation system 10 in this configuration includes a mobile unit 14 operable to communicate with the main system 12. The mobile unit 14 may be a PDA (personal digital assistant), laptop computer, telephone, three-in-one device or other portable electronic devices capable of communicating with the main system 12. In one aspect, the mobile unit 14 is in wireless communication with the main system 12 such as via cellular communication. It will be appreciated that in some aspects, the mobile unit 14 may be in wireless communication with the main system 12 such as via RF Communication Digital or other similar wireless communication technology utilized now or in the future for these purposes.

The mobile unit 14 includes an input portion 18 for inputting information into the mobile unit 14, which can include, but is not limited to, keypads, pointing devices, touch-screens, and other input systems utilized for these purposes. The evaluation system 10 may further include an inspection survey database 20 for storing and organizing information related to the inspection of a construction site. In one configuration, at least a portion of the inspection survey database 20 reside on either a storage portion of the main system 12 or a storage portion of the mobile unit 14. And, in some configurations, at least a portion of the inspection survey database 20 resides on both the storage portion of the main system 12 and the storage portion of the mobile unit 14.

The storage portion of the main system 12 may include virtually any known storage device now known or later developed by one of ordinary skill in the art, including, but not limited to computer hard-drives, floppy drives, optical disk or disk servers, and other devices for storing and retrieving information for such purposes. The storage portion of the mobile unit 14 may include similar device or other storage device utilized by handheld portable devices such as the mobile unit 14, for example, memory cards or other storage devices. One advantage of the present invention is the ability to utilize any operating system, including, but not limited to Windows CE, and Palm OS.

The evaluation system 10 may further include an inspection survey interface 22 in communication with the inspection survey database 20 and the input portion 18 of the mobile unit 14. The inspection survey interface 22 is operable to update the inspection survey database 20 via the mobile unit 14. In some aspects, a complimentary component of the inspection survey interface 22—which includes some, all or additional attributes of the inspection survey interface 22,—may be utilized by a workstation 24, such as a computer workstation or PC connected to the main system 12 as a work station of a computer network. However, some modification to the inspection survey interface 22 may be useful for deployment for use by the workstation 24. Although the inspection survey interface 22 utilized for the mobile unit 14, main system 12 and workstation 24 may be the same or different, for the purposes of clarity and simplicity of this disclosure, these interfaces, regardless of the system accessing the interface, will be referred to herein as the inspection survey interface 22.

The evaluation system 10 advantageously allows an inspector to utilize the mobile unit 14 while conducting inspection surveys of construction sites. By utilizing the inspection survey interface 22, the inspector may input, using the input portion 18 of the mobile unit 14, data related to the inspection into the inspection survey database 20. Where the inspection survey database 20 is not resident on the mobile unit 14, the mobile unit 14 may wirelessly communicate with the inspection survey database 20 resident on the main system 12 to directly update and input survey information into the inspection survey database 20.

In one configuration of the invention, the evaluation system 10 further comprises a synchronization module to periodically synchronize the portion of the inspection survey database 20 stored on the mobile unit 14 with the portion of the inspection survey database 20 stored on the main system 12. In this configuration, both the mobile unit 14 and the main system 12 may be provided with substantially identical inspection survey databases 20. The synchronization module is provided to update, for example, newly input or modified inspection information in the inspection survey database 20 resident on the mobile unit 14 and synchronize with that of the inspection survey database 20 resident on the main system 12.

The synchronization module, according to one aspect, is a computer program resident on the main system 12 and/or mobile unit 14 operable for synchronizing files or databases, such that the files or databases are substantially identical to one another after the synchronization is processed by the synchronization module. Synchronization programs for these purposes may be programmed using well known techniques to efficiently create, duplicate or mirror files on multiple systems. The synchronization system of the present invention will be discussed in greater detail hereafter. The synchronization module of the evaluation system 10 provides another advantage of the present invention since the inspector is allowed to periodically transmit inspection survey information to the main system 12 from the mobile unit 14 while at a location remote to the main system 12.

In other configurations, the database 20 resident on the mobile unit 14 may contain more or less data than that resident or accessible by the main system 12 or workstation 24. In this configuration, the synchronization module is operable to synchronize only the fields or portions of data resident in both inspection survey databases 20. While several synchronization techniques and devices are described herein, it should be expressly understood that other synchronization techniques can be utilized as will become apparent to one skilled in the art.

Once a particular inspection survey has been uploaded to the inspection survey database 20 resident on the main system 12, a quality reviewer may utilize the workstation 24, for example, to review a particular inspection report and verify that the inspection was completed and that the appropriate information was inspected and properly recorded. The reviewer may note any deficiencies in the survey, such as where the survey was incomplete or where the survey indicates that the construction site does not pass inspection. In the event additional information is needed to complete the survey, the quality reviewer may mark the survey, such as by flagging a record (not shown) or field within the inspection survey database 20 so that such information can be transmitted to the mobile unit 14.

This process may also occur periodically, for example, where the inspector utilizing the mobile unit 14 initiates the synchronization module and the quality reviewer's comments are downloaded to the mobile unit 14 and viewable via the inspection survey interface 22. This provides yet another advantage of the present invention since the inspection may be quickly brought to a conclusion without the need for the inspector to return to the inspection office and re-type the survey, or otherwise have the survey reviewed by the quality reviewer and subsequently return to the inspection site before passing the construction site's inspection.

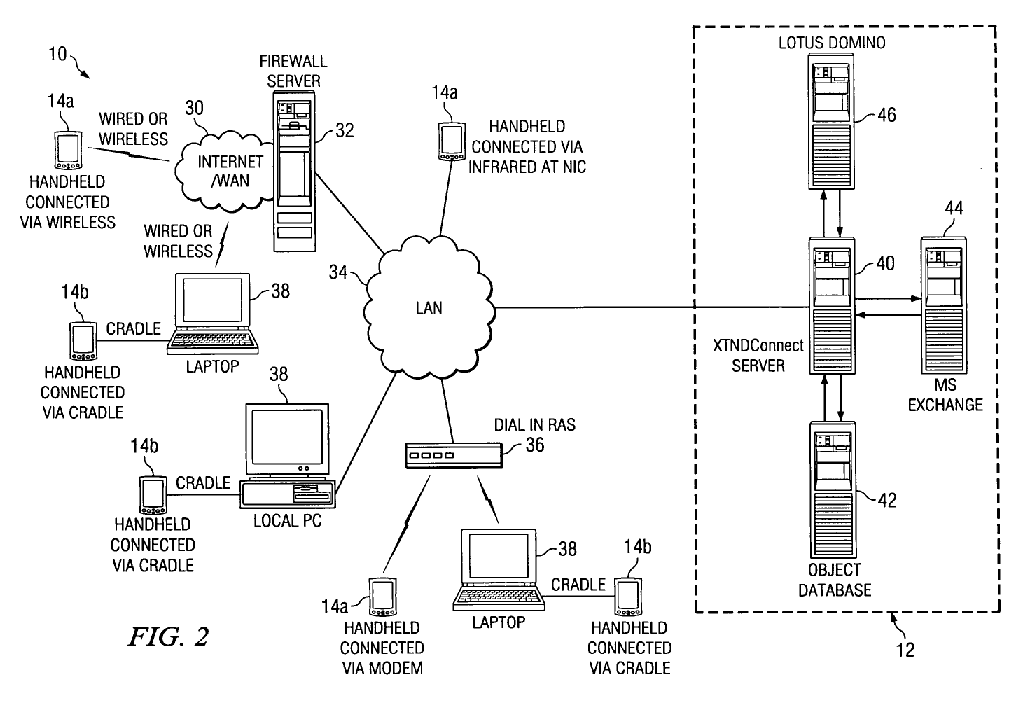

FIG. 2 illustrates others aspects of the invention, namely another configuration of the main system 12 and a plurality of mobile units 14 that can be utilized with the evaluation system 10 of the present invention. In this aspect, the mobile units 14a may communicate with the main system 12, using virtually any communication technique, now known or later developed. For example, the mobile units 14a may communicate wirelessly or in a wired communication fashion to the main system 12 via the Internet, world wide web or wide area network 30 through a firewall server 32, utilized for security to the local area network 34 connected to the main system 12. The wireless mobile units 14a may also communicate with the local area network 34 via a dial-up connection, such as to a modem or a modem server 36. Also, the mobile units 14a may connect via well known infrared or other technologies directly to the local area network 34, such as 802.11b.

It will be appreciated by those skilled in the art that yet other communication techniques can be utilized. For example, mobile units 14b, may utilize a cradle to connect to a laptop or a desktop computers that, in turn, may be connected to the local area network 34, or wirelessly in communication with the local area network 34, such as via the modem or modem server 36 or the Internet 30. In this aspect, it can be seen that the evaluation system 10 of the present invention may utilize a number of communication platforms and technologies for the communication between the main system 12 and the mobile unit 14 for sharing inspection information stored in the inspection survey database 20. The communication technologies set forth in FIG. 2 are intended as only illustrating several of the communication technologies that can be utilized with the invention. As such, it should be understood that other communication technologies may be utilized, including those that are currently known and those that will be developed at a later time.

In the aspect illustrated in FIG. 2, the inspection survey database 20 may include a plurality of smaller files or databases resident on the storage portion of the mobile unit 14. In a preferred configuration, an XTNDConnect server 40 is utilized as the synchronization module. However, it will be appreciated that other synchronization modules may be custom programmed modules or provided by other systems with such capabilities. The inspector initiates a wireless connection from the mobile unit 14 to, for example, the Internet 30. As an example, the mobile unit 14 may be provided with a wireless communication card or modem (not shown) to establish a circuit and/or packet switch connection to the nearest cellular tower (not shown). The mobile card or wireless modem will then receive an IP (Internet Protocol) address to allow the mobile unit 14 to access resources on the Internet.

Once the Internet connection is established, the inspector may initiate the synchronization session utilizing, for example, an XTNDConnect client which is an application resident on the mobile unit 14 and compatible with the XTNDConnect server 40 and used for synchronization of files, such as between files stored on the database server 42 of the main system 12 and the inspection survey database 20 stored on the storage portion of the mobile unit 14.

The XTNDConnect client may take a snapshot of the inspection survey database 20 resident on the mobile unit 14 and transmit this snapshot image of the inspection survey database 20, via the Internet 30 and local area network 34, to the XTNDConnect server 40. It will be appreciated that the information communicated in this manner may be encrypted for security and other purposes, utilizing encryption and decryption technologies and algorithms well known in the art, such as the 128 bit Elliptical Curve Encryption available from Certicom.

The XTNDConnect server 40 may either obtain a snapshot of the inspection survey database 20 resident on the database server 42 and compare the image with that received from the mobile unit 14 or, according to other aspects, may compare the snapshot image received from the mobile unit 14 directly with the file attributes of the inspection survey database 20 resident on the database server 42. Any differences, such as changes to the inspection survey database 20 made by the inspector, via the mobile unit 14, or the reviewer, via the workstation 24, are applied to synchronize the inspection survey database 20 resident on the mobile unit 14 with that of the inspection survey database 20 resident on the database server 42.

It will be appreciated that for data communication and transmission efficiency only the changes or differences between these databases may be transmitted between the mobile unit 14 and the main system 12 to accomplish the synchronization process. The XTNDConnect server 40 sends a signal to the mobile unit 14 indicating that a successful synchronization has occurred or repeats the process until it is successful. The wireless communication capabilities of the mobile unit 14 can utilize any wireless system, whether GSM, CDMA, or other wireless platforms and devices; although, in one configuration, a nation-wide, high-speed data network may be useful.

In one configuration, the main system 12 may include a Microsoft Exchange Server 44 and a Lotus Domino server 46—both in communication with the XTNDConnect server 40. In many instances, it may be useful for the inspector to have access to email, calendar and scheduling functions on the mobile unit 14 and as such, synchronization of email and calendaring, for example, may be accomplished through the synchronization process via the XTNDConnect server 40 similar to the manner in which synchronization is accomplished with the database server 42.

When the inspector initiates the synchronization module from the mobile unit 14, not only is the inspection survey database 20 synchronized, but also email, calendar, and other databases useful to the inspector may be synchronized as well. In one aspect the inspector and quality reviewer may communicate with regard to the inspection via email and, while the inspection survey database 20 is synchronized, additional information regarding particular inspections may be passed between the main system 12 and the mobile unit 14 via email utilizing the XTNDConnect server 40 and Lotus Domino Server 46, for example.

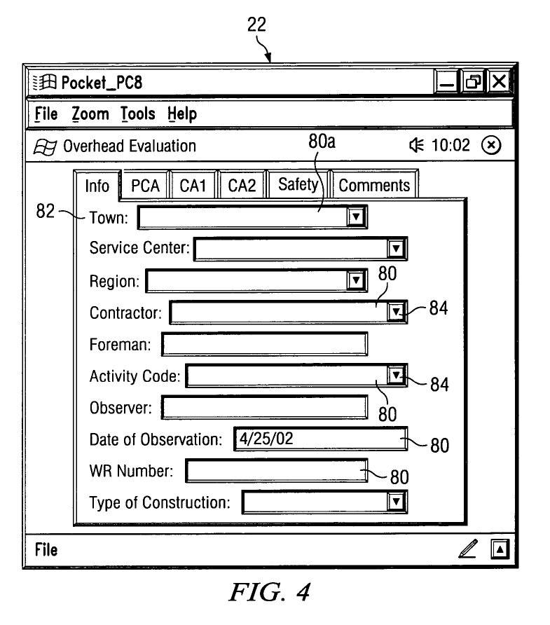

FIG. 3 is a block diagram illustrating the association of the inspection survey database 20 and the inspection survey interface 22 according to one aspect of the present invention. The evaluation system 10 may be useful, for example, for inspecting construction sites, such as where contractors for utility companies construct electrical facilities for the transmission and distribution of electricity. In these instances, the contractors may assume the role of working on behalf of the electric utility or constructing the facility for a third party where the facility will ultimately be connected to the electrical grid.

In either event, these facilities must be inspected by the utility to ensure that quality materials, safety guidelines and the construction adhere to regulations required by, for example, state regulating authorities, or adhere to contractual obligations between the contractor and the utility. Electrical facilities constructed for these purposes may take the form of either underground or overhead electrical facilities.

For inspection purposes, the evaluation of overhead and underground facilities require different inspection criteria. The inspection survey interface 22 of the present invention may usefully provide an underground evaluation form 50 and an overhead evaluation form 52. The overhead and underground evaluation forms 50 and 52 are provided with graphic user interface or other interfaces useful for receiving applicable information into such systems.

The inspection survey database 20 includes, in the present aspect, a plurality of tables 54 for obtaining information associated with the inspection survey interface 22. The tables may be standard database or electronic files organized or parsed so as to efficiently organize and store data for these purposes. In one configuration the tables 54 are organized and compatible for SQL or ODBC access while in other configurations, the tables 54 may be organized as tables or flat files or in file structures according to other compatible or desired systems. Yet other configurations should be recognized by one skilled in the art.

The tables 54 include an overhead table 56 and an underground table 58 for storing information unique to the underground and overhead facilities and corresponding to the unique criterion for these inspections input into the underground and overhead evaluation forms 50 and 52. Information common to both the underground and overhead evaluation forms 50 and 52 may be maintained in common tables 60 such as a town table 62 identifying the town where the construction site is located, a service center table 64 for maintaining information related to the utilities regional service center under which the construction site is associated, a region table 66 indicating the general region associated with the construction site, a contractor table 68 for maintaining information about the contractor building the construction site, an activity code 70 which may maintain, for example, information related to the type of inspection or survey, and a user table 72 for maintaining information about the inspector conducting the inspection.

The common tables 60 maintain information associated with both the underground and overhead evaluation forms 50 and 52, while the overhead and underground 56 and 58 tables are uniquely associated with the relevant underground or overhead evaluation forms 50 and 52. A plurality of additional tables, or in some instances, fewer tables may be utilized for these purposes. Furthermore, the association of the tables 54 with the inspection survey interface 22 may be modified and still remain within the spirit and scope of the present invention. Additionally, the tables 54 discussed with reference to FIG. 3 are only illustrative of the many types of tables 54 that can be utilized as others will be become apparent to those skilled in the art—such tables, to a certain degree, depending on the intended use of the evaluation system 10.

Additional information relevant to the inspection survey database 20 as well as a number of graphical user interfaces 22 that may be employed by the inspection survey interface 22 are provided in Appendix A of the Provisional Patent Application Serial No. 60/436,413, from which this application claims priority and of which is incorporated by reference, herein. In some configurations the inspection survey database 20 may be maintained completely on the main system 12 or accessible by the main system 12, while in other configurations, the inspection survey database 20 may be partially resident on the main system 12 and partially resident on the mobile unit 14 for efficiency. Also, the inspection survey interface 22 may be provided with certain interfaces used by a quality reviewer, such as via the workstation 24, and other interfaces provided only on the mobile unit 14 for use by the inspector. In some aspects, however, the inspection survey interface 22 may be the same on both the main system 12 and the mobile unit 14.

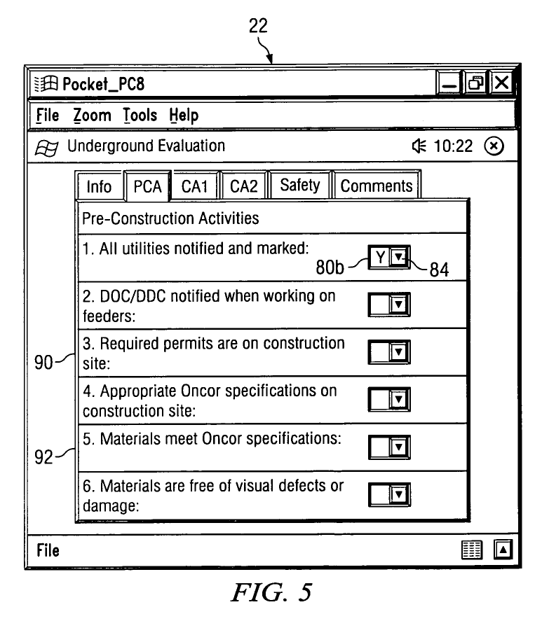

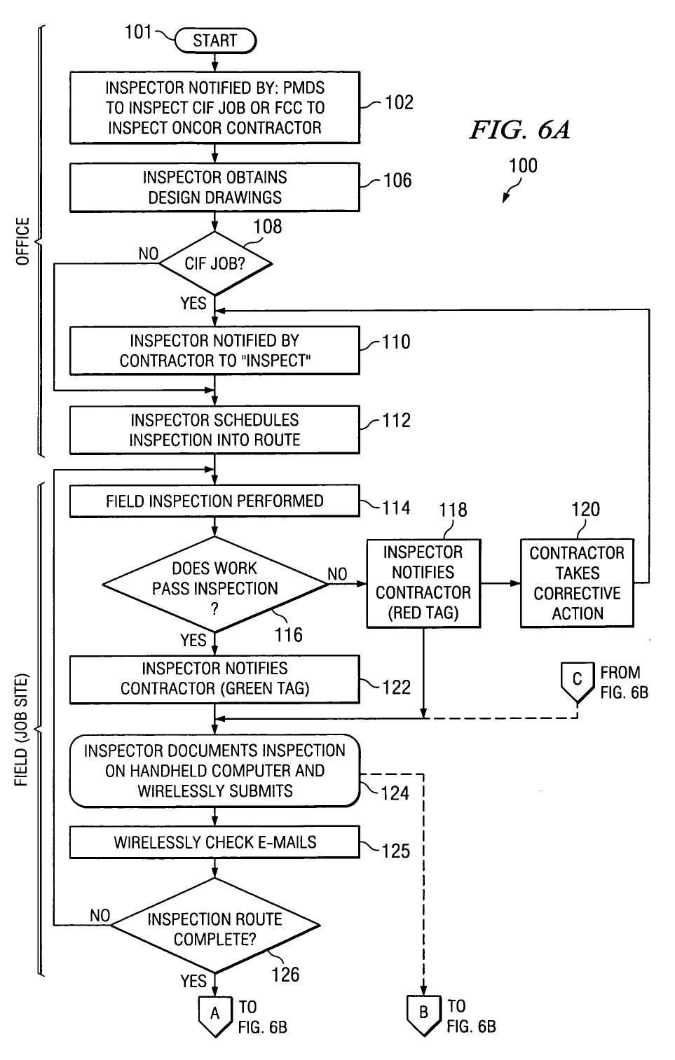

FIGS. 4 and 5 in an illustration of another aspect of the invention, show inspection survey interfaces 22 useful for the inspector and the quality reviewer for analyzing inspection survey information resident on the inspection survey database 20 located on either the mobile unit 14 or the main system 12. The inspection survey interface 22 provides information corresponding to the tables 54 and is provided with a plurality of input cells 80 corresponding to labels 82 indicating that a particular input cell 80 is associated with one of the tables 54. For example, the town table 62 is associated with the town label 82 and input cell 80a. A number of the cells 80 and labels 82 may correspond to unique information and may be maintained in the tables 54 or other tables.

The input cells 80 may be provided with a pull-down button 84 whereby the inspector may view a list of, for example, towns to ease inputting of information into the inspection survey interface 22. In some aspects, the mobile unit 14 may be provided with a keyboard to enter data, or a pointing device may be utilized or, in some aspects, the mobile input unit 14 may recognize handwriting, which may be written onto a touch-screen or other device by a stylus or other pointing device for quickly entering alpha-numeric or other information into the inspection survey interface 22. As referenced above, other input techniques can be utilized as should be recognized by those skilled in the art.

Referring to FIG. 5, it will be appreciated that the inspection process requires that the inspector physically observe the inspection site to ensure that certain inspection criteria have been met. This may be usefully documented by the evaluation system 10 of the present invention by providing questions which may require brief or more detailed answers; however, in certain instances “Yes” and “No” may be an appropriate response to questions or checklist items.

For example, a particular checklist item, such as whether the required permits are at construction site 90 may be associated with the input cell 80b. The inspector may use the pull-down button 84 to select between “Yes,” “No” and perhaps “Not observed” or leave the input cell 80 incomplete in some instances. In any event, the inspection survey interface 22 may include a plurality of additional survey questions or checklist items 92 associated with input cells 80 which are completed by the inspector.

Although the input cells 80 illustrated in the current figures provide for only brief responses, it should be understood that other input cells 80 (not shown) may be provided for lengthy commentary by the inspector, or reviewer. Additionally, there may be comment or question fields provided in certain configurations of the inspection survey interface 22 and useful for question and commentary purposes.

The forms, as with other portions of the present invention, may be implemented utilizing well-known programming techniques. The computer application of the present invention may be programmed, for example, using Microsoft's Embedded Visual Basic 3.0, or other programming languages well known in the art, today, or that are developed at a later time.

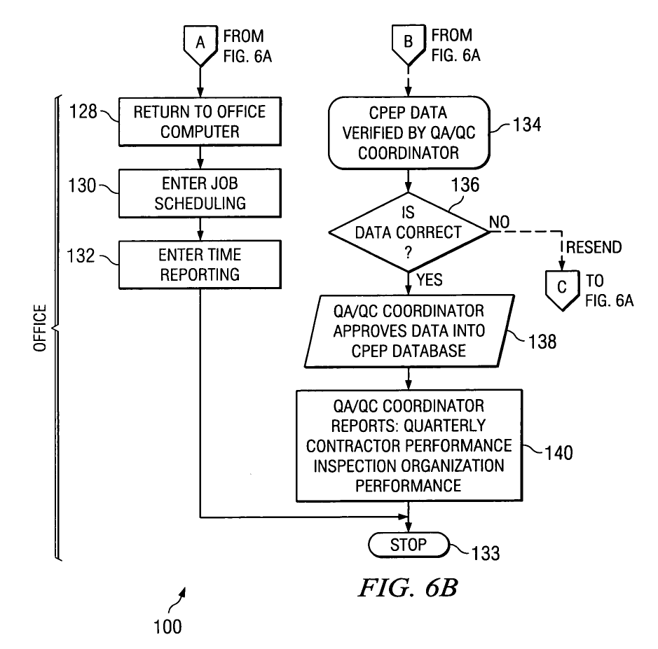

FIG. 6 is a flowchart illustrating a method 100 for surveying and inspecting a construction site prior to initiating electric service to a site or facility. The method starts, at a block 101 and includes, at a block 102, notifying the inspector, to inspect a contractor installed facility (CIF) or by Field Contractor Coordinator (FCC) to inspect a utility contractor construction site. At a block 106, the inspector obtains design drawings of the construction site an any additional information necessary to perform the inspection.

A decision, at a block 108, determines whether the job or site is a contractor installed facility (CIF). Where the site is a contractor installed facility, at a block 110, the inspector is notified by the contractor or customer to perform the inspection. Thereafter, and in the event the site is not a contractor installed facility (CIF), the method proceeds to a block 112, where the inspector schedules the inspection into the route, such as by inputting via the inspection survey interface 22, the date, time and location of the inspection. At the block 112, the inspector, or other users of the main system 12 may load information relative to the inspection in the inspection survey database 20 and such general information about the, for example, contractor, construction site, location and other information may be loaded into the mobile unit 14 during a synchronization between the mobile unit 14 and the main system 12.

At a block 114, the inspector performs the field inspection of the construction site. At the block 114, the inspector observes the construction site and completes the inspection survey interface 22 questions, comments, and other information via the inspection survey interface, which is stored on the storage portion of the mobile unit in the inspection survey database 20.

At a block 116, the inspection generally and the survey, via the inspection survey interface 22, is viewed to determine whether the construction site passes inspection. Where the construction site does not pass inspection, at a block 118, the inspector notifies the customer, such as the contractor, in person or by a red tag process identifying that the construction site has failed inspection. In this event, the method proceeds to a block 120 where the customer may take corrective action to remedy any deficiencies at the construction site which caused the site not to pass the inspection.

In some instances, the contractor may take corrective measures or otherwise delay the inspection and subsequently reinitiate the inspection process. In this event, the method returns to the block 110 when the contractor notifies the inspector to reinitiate the inspection. Also, once the inspector notifies the contractor, at the block 118, the inspector documents at a block 124, as described above and/or verifies the inspection on the mobile unit 14 for wireless submission to the main system 12.

Where the construction site passes inspection at the block 116, the method proceeds to a block 122 where the inspector notifies the customer in person or by green tag process that the construction site has passed the inspection process. Regardless of the result of the inspection, at the block 124, the inspector utilizes the input portion 18 of the mobile unit 14 and completes the inspection survey information into the inspection survey database 20, via the inspection survey interface 22. At the block 124, the inspector initiates the synchronization module to synchronize the inspection survey database 20, as well as the other databases such as email and schedules, related to the next day's route. Simultaneously or independently at another time, the inspector may, at a block 125, wirelessly check email or other information, such as modification to scheduling, or to receive information regarding whether current or prior inspection have been verified and accepted by the quality reviewer via the main system 12.

At a block 126, the inspector may determine whether additional inspections are scheduled based on a review of the scheduling database. This may be accomplished using a paper system, by an electronic calendaring and scheduling system, such as commonly employed, alone or as a linked, embedded object or integral part of the inspection survey database 20. In the event additional inspections are scheduled, the method proceeds to the block 114, and where no additional inspections are scheduled, at a block 128, the inspector returns to the office computer, such as the workstation 24 of the main system 12. At that time, at a block 130, the inspector enters job status in the scheduling process and, at a block 132, the inspector enters time reporting and may attend to other associated matters related to documenting and completing the inspection and readying for subsequent inspections. The method is completed at a block 133.

During the synchronization, at the block 124, the inspection survey database 20 is synchronized with the main system 12 and viewed and verified by the quality reviewer, at a block 134, for quality assurance and quality control purposes. At this block 134, the quality reviewer analyzes the inspection survey, via the inspection survey interface 22 to determine whether all the information necessary to complete the survey was accurately and appropriately recorded in the inspection survey database 20, and also determines whether the inspector properly passed or failed the site's inspection.

At a block 136, the inspection survey and data is verified and where an incomplete inspection, an inaccurate assessment, other problems or issues are identified by the quality assurance/quality coordinator (QA/QC) reviewer, at a block 136, the particular survey, which may be identified as a record in the inspection survey database 20 or other field of the inspection survey database 20 is flagged or identified in the manner that initiates the synchronization of the particular survey for retransmission to the mobile unit 14 during the next synchronization process. In this event, the method proceeds to the block 124 for review or other corrective action by the inspector. Automatic routines to identify data errors or deficiencies in the inspection survey may also be utilized. Furthermore, the quality reviewer, at the blocks 134 and 136 may input questions or comments in certain fields or input cells 80 of the inspection survey interface 22 and into the inspection survey interface database 20.

Identifying aspects, such as reminder or attention windows or sounds, notify the inspector that a deficiency in a particular inspection has been identified by the quality reviewer. The inspector, at the block 124, may reanalyze a particular inspection and potentially reinspect the construction site or communicate with the customer or contractor further with respect to the quality reviewer's comments.

Where the survey, including the inspection survey data, was accurately completed, the quality reviewer approves the survey data into the inspection survey database 20, at a block 138. Receipt or verification into the inspection survey database 20 may be accomplished, according to one aspect of the invention, by providing a status field in the record, such as pending or otherwise flagging the inspection survey record. In this case, only the quality reviewer, for example, is provided with security access or is able to view and modify the status of the flag identifying the inspection as pending or completed.

At a block 140, the quality reviewer may generate reports on contractor performance or other reports related to the inspection survey database 20 and may also supply relevant information to administrative, and other individuals within the organization, to the contractor or others. It will be appreciated that in some aspects, the survey may be provided and analyzed for performance to ensure that the contractor is meeting certain standards of quality workmanship and timeliness for various purposes, including contract bonuses and other benefits for successfully passing inspections. In some aspects the inspection surveys may be scored or weighed to determine the performance of the contractor based on the answer to specific questions in the survey.

One advantage of the present invention is that the inspector is able to save a particular inspection when only partially completed, in the inspection survey database 20, and can quickly and easily reinitiate the survey by recalling the information on the mobile unit 14. This eliminates the need of keeping up with paper work or recalling information about a particular inspection or construction site.

Furthermore, the survey information is entered only once on the mobile unit 14 eliminating the need to reenter information at the main system 12 and further eliminating data entry errors. Another advantage of the present invention is that the inspector may receive and transmit survey and inspection information to and from the main system 12 without being required to travel between the construction sites and the inspector's office for such information. This provides a considerable time savings for the inspector and the inspecting business, such as the electric utility.

One advantage provided by the present invention is the ability to store the survey information in the inspection survey database 20 and the mobile unit 14 while in the field is particularly useful in instances where the inspection or construction site is located at a location where wireless or other communication with the main system 12 is not possible. In such events, the information is stored and retained on the mobile unit 14 until the mobile unit 14 is returned to a location within the coverage of the wireless network utilized by the evaluation system 10 of the present invention.

Thus, it is apparent that there has been provided, in accordance with the present invention, a mobile contractor performance evaluation system that satisfies one or more of the advantages set forth above. Although the preferred embodiment has been described in detail, it should be understood that various changes, substitutions, and alterations can be made herein without departing from the scope of the present invention, even if all of the advantages identified above are not present. For example, the various elements or components may be combined or integrated in another system or certain features may not be implemented.

Also, the components, techniques, systems, sub-systems, layers, compositions and methods described and illustrated in the preferred embodiment as discrete or separate may be combined or integrated with other components, systems, modules, techniques, or methods without departing from the scope of the present invention. Other examples of changes, substitutions, and alterations are readily ascertainable by one skilled in the art and could be made without departing from the spirit and scope of the present invention.

What is claimed is:

1. A method of surveying an site prior to initiating service to the construction site, the method comprising:
providing a mobile unit having a communication portion and a storage portion;
providing an construction site survey on the mobile unit for inspecting overhead and underground construction sites, the construction site survey including criteria for evaluating whether the construction site is prepared to receive service;
inspecting the construction site;
entering survey data into the construction site survey on the mobile unit based on the inspection of the construction site;
storing the survey data on the storage portion of the mobile unit;
transmitting at least a portion of the survey data from the mobile unit to a main system;
evaluating the survey data received by the main system to verify whether the construction site is prepared to receive service;
transmitting survey response data from the main system to the mobile unit; and
evaluating the survey response data to determine whether the construction site satisfied the criteria for receiving service.

2. The method of claim 1, wherein the transmission of at least a portion of the survey data from the mobile unit to a main system is a wireless transmission.

3. The method of claim 1, wherein the service is electrical service.

4. The method of claim 1, wherein the evaluation of the survey data received by the mobile unit from the main system further includes evaluating whether the construction site fails to satisfy the criteria for receiving service and in such event, the method further comprises:
re-inspecting the construction site;
entering additional survey data;
re-transmitting the survey data from the mobile unit to the main system;
re-evaluating the survey data; and
re-transmitting the survey response data from the main system to the mobile system based on the re-evaluation of the survey data.

5. The method of claim 4, wherein the transmission of at least a portion of the survey data from the mobile unit to a main system is a wireless transmission.

6. The method of claim 5, wherein the transmission of the survey response data from the main system to the mobile unit is a wireless transmission.

7. The method of claim 1, wherein the survey data includes comments data, a flag indicative of a response to yes/no questions, and data related to the location of the construction site and indication of whether the construction site satisfied the criteria for receiving service.

8. The method of claim 1, further comprising:
modifying the survey data on the mobile unit;
synchronizing the survey data on the main system with the survey data on the mobile;
modifying the survey data on the main system; and
synchronizing the survey data on the mobile system with the survey data on the main system.

9. The method of claim 1, further comprising:
notifying a user of the main system that the survey data has been received from the mobile system; and
notifying the user of the mobile system that the survey response data has been received from the main system.

10. The method of claim 1, further comprising:
initiating service to the construction site.

11. The method of claim 1, further comprising:
saving the survey data to complete the inspection at a later time.

12. A mobile performance evaluation system for inspecting a site, comprising:
a main system including a storage portion;
a mobile unit operable to communication with the main system, the mobile unit including a storage portion and an input portion;
an inspection survey database including information related to the inspection of the site, wherein at least a portion of the inspection survey database resides on at least one of the storage portion of the main system and the storage portion of the mobile unit; and
an inspection survey interface in communication with the inspection survey database and the input portion of the mobile unit to update the inspection survey database via the mobile unit.

13. The mobile performance evaluation system of claim 12, wherein at least a portion of the inspection survey database is stored on the storage portion of the main system and the storage portion of the mobile unit.

14. The mobile performance evaluation system of claim 13, further comprising:
a synchronization module to periodically synchronize the portion of the inspection survey database on the storage portion of the mobile unit with the portion of the inspection survey database stored on the storage portion of the main system.

15. The mobile performance evaluation system of claim 12, wherein the mobile unit is operable to update a first portion of the inspection survey database and wherein the main system is operable to update a second portion of the inspection survey database.

16. The mobile performance evaluation system of claim 12, wherein the inspection survey database includes a verification portion to verify the inspection of the site.

17. The mobile performance evaluation system of claim 16, wherein the verification portion of the inspection survey database is further defined as verification data indicative of whether the inspection of the site was completed.

18. The mobile performance evaluation system of claim 16, wherein the verification portion of the inspection survey database is further defined as verification data indicative of whether additional information is needed for the site to pass inspection.

19. The mobile performance evaluation system of claim 12, wherein the mobile unit is in wireless communication with the main system.

20. The mobile performance evaluation system of claim 12, wherein the inspection survey database is further defined as a first database stored on the storage portion of the mobile unit and a second database stored on the storage portion of the main system.

21. The mobile performance evaluation system of claim 20, wherein the first and second databases include inspection survey data related to inspection of a construction site.

22. The mobile performance evaluation system of claim 21, wherein the inspection survey data includes inspection location data, contractor data, date of inspection data, and data to indicate whether the site inspected is one of an overhead or an underground construction site.

23. The mobile performance evaluation system of claim 20, further comprising a synchronization module to synchronize the first and second databases.

24. The mobile performance evaluation system of claim 12, wherein
the inspection survey database completely stored on the main system and,
the mobile system wirelessly updates the inspection survey database on the main system.

25. The mobile performance evaluation system of claim 12, further comprising:
an email database and a calendar database, wherein
at least a portion of the email and calendar databases are stored on the storage portions of the main system and the mobile system.

26. The mobile performance evaluation system of claim 25, further comprising:
a synchronization module, operable to synchronize the portions of the inspection survey database residing on the storage portions of the mobile system and the main system.

27. The mobile performance evaluation system of claim 26, wherein the synchronization module is further operable to synchronize the portions of email and calendar databases on the storage portions of the main system and the mobile system.

28. The mobile performance evaluation system of claim 12, wherein the site is a construction site and wherein the inspection survey database retains information related to a construction site.

29. The mobile performance evaluation system of claim 12, wherein
the site is an electrical construction site, and
the inspection survey database retains information related to an electrical construction site.

30. The mobile performance evaluation system of claim 28, wherein the construction site information includes overhead electrical construction site information.

31. The mobile performance evaluation system of claim 28, wherein the construction site includes underground electrical construction site information.
